(19) United States
(12) Patent Application Publication
(10) Pub. No.: US 2026/0170893 A1
(43) Pub. Date: Jun. 18, 2026

(54) Smart locker device

(71) Applicant: BLOQSTRX, S.A., Lisboa (PT)

(72) Inventors: Ricardo Alexandre DE JESUS CARVALHO, Lisboa (PT); João Tiago OLIVEIRA SOUSA NOGUEIRA LOPES, Lisboa (PT); Miha JAGODIC, Lisboa (PT)

(73) Assignee: BLOQSTRX, S.A., Lisboa (PT)

(21) Appl. No.: 19/419,455

(22) Filed: Dec. 15, 2025

(30) Foreign Application Priority Data
Dec. 13, 2024 (PT) 119903

(51) Int. Cl. G07C 9/00

(52) U.S. Cl. CPC G07C 9/00571; G07C 9/00896; G07C 2009/00642; G07C 2009/0065

(57) ABSTRACT

A smart locker device that includes a plurality of locker compartments, each locker compartment including an electronic lock; a central control unit configured to manage access to said plurality of locker compartments; a user interface configured to enable users to interact with the device and control access to one or more of the plurality of locker compartments; a communication module for remote monitoring and control of the locker device; a power source; wherein the central control unit is configured to manage operational states of the smart locker device, including a sleep state and an active state.

### CROSS-REFERENCE TO RELATED APPLICATIONS

This application claims the benefit of priority under 35 U.S.C. § 119 from Portugal Patent Application No. 119903, filed Dec. 13, 2024, which is hereby incorporated by reference as if set forth in its entirety herein.

### TECHNICAL FIELD

The present disclosure relates to a smart locker device for automated storage and retrieval.

More specifically, it relates to a smart locker device equipped with compartments provided with electronic locks, low-power operational modes, multi-trigger wake-up mechanisms, remote communication capabilities, and autonomous energy management suitable for deployment in environments with limited power availability.

### BACKGROUND

The demand for smart locker systems has grown significantly with the advent of e-commerce and contactless delivery solutions. However, traditional smart locker systems require continuous internet connectivity and rely heavily on manual user inputs for activation and management, limiting their adaptability to dynamic environments, such as remote locations or high-traffic areas.

Traditional smart lockers require constant internet connectivity to remain operational. These devices are often designed to stay connected to a network 24/7, regardless of whether a transaction is taking place. This constant connectivity exposes the system to network vulnerabilities, such as security breaches or connectivity interruptions, and also leads to high energy consumption, particularly in locations with limited power supply.

Many existing smart locker solutions rely on pre-configured or user-initiated schedules to determine when the device should be operational. For example, some devices are set to specific hours of operation or require users to manually activate locker access through a mobile app. While this provides basic functionality, it does not optimize for unpredictable user behaviour or changing delivery patterns, resulting in inefficiencies.

Connectivity issues are also a common problem in current smart locker devices. These devices are often dependent on a single type of network, such as Wi-Fi or cellular, which makes them vulnerable to outages. When connectivity is lost, the lockers may become inoperable, requiring manual intervention to restore functionality or retrieve packages. This dependency on continuous connectivity reduces the device's reliability, especially in remote or rural areas.

Another limitation of traditional smart lockers is their energy consumption. Because most systems remain powered on at all times, they consume a significant amount of electricity, even during periods of inactivity. This is particularly problematic in locations where energy resources are scarce or expensive, and it poses challenges for deploying smart lockers in eco-friendly or off-grid environments.

While some existing lockers include basic power-saving features, such as dimming displays or entering standby modes, these are typically insufficient to address the broader problem of energy efficiency. Smart lockers need more advanced solutions that allow them to wake up and activate only when necessary, without compromising user experience or system performance.

User interaction with many smart lockers remains basic, often involving input of codes or scanning of barcodes (e.g., using Quick Response (QR) code Scanner 403 in FIG. 4) to access the contents of a locker. While effective in controlled environments, such methods do not provide a seamless, intuitive experience for the user. There is a growing need for systems that can integrate more advanced access technologies, such as biometrics or AI-driven recognition, to improve security and usability.

Current devices also lack adaptive intelligence in terms of operational management. For example, many lockers are unable to adjust their behaviour based on patterns of use, peak times, or other contextual factors. This rigidity limits their ability to operate efficiently in high-traffic environments, where lockers may be overused, or low-traffic environments, where they remain idle for long periods.

Another challenge faced by existing smart locker devices is their inability to scale effectively across different types of locations. A device that works well in an urban environment, where connectivity and power are readily available, may struggle in rural or industrial locations. These environments often require a more adaptable and autonomous device that can operate independently of external network or power sources for extended periods.

Remote management of smart locker devices is generally limited in existing solutions. System administrators often need to be physically present to troubleshoot issues, perform software updates, or manage locker access. This not only increases operational costs but also reduces the scalability of the system. The need for a fully autonomous locker device that can be managed and updated remotely, without human intervention, remains largely unmet.

Although some lockers include basic security features, such as access logs or tamper alarms, these features are generally reactive rather than proactive. Most devices are unable to detect potential security threats before they occur or respond autonomously to suspicious activity. This limits their effectiveness in environments that require heightened security measures, such as corporate offices or high-traffic public areas.

The integration of smart lockers with external platforms, such as e-commerce websites or delivery services, is often cumbersome and requires significant manual setup. This lack of seamless integration can result in delays, errors in deliveries, and poor user experiences, particularly when systems are not designed to communicate effectively with third-party applications.

Existing smart lockers typically fail to incorporate advanced artificial intelligence (AI) technology, which could significantly enhance their performance. AI could allow lockers to learn from user behaviours, predict delivery times, and optimize operational efficiency based on real-time data. The absence of such intelligent features in most devices leads to missed opportunities for improving both energy usage and user satisfaction.

Many of today's smart lockers are also inflexible when it comes to deployment in varying environments. Urban settings, rural areas, and high-security locations each present unique challenges that require different configurations of lockers. Current devices often need manual reconfiguration or replacement to adapt to these environments, making it difficult to deploy them cost-effectively on a large scale.

While there has been some progress in developing more sophisticated smart locker systems, there remains a significant gap in providing a solution that combines full autonomy, on-demand connectivity, and AI-powered features. The demand for a smart locker system that can operate independently, optimize energy usage, and integrate seamlessly with other technologies continues to grow as the limitations of existing systems become more apparent.

Document US2023210295A1 discloses systems and methods for smooth attended or unattended package delivery and retrieval may be provided through a container locker. Delivery companies and their respective delivery means may interact with the container locker wirelessly, through handheld devices, or through mechanisms provided on the container locker itself. The processes of receiving or pickup of a parcel or other item may be facilitated, regardless of the user's presence or absence from the delivery/pickup location. Systems and methods may receive, secure, maintain, and temporarily house delivery or pickup items and concomitantly document, verify, confirm, and communicate data in varied forms to the parties interested or engaged in such deliveries or retrievals through a variety of connected networks, communication means and the use thereof.

These facts are disclosed in order to illustrate the technical problem addressed by the present disclosure.

### GENERAL DESCRIPTION

The present disclosure relates to a smart locker device for automated storage and retrieval.

The present disclosure relates to a smart locker device for automated storage and retrieval that significantly improves upon prior art by providing enhanced functionality, energy autonomy, security, and integration features. This device is designed to streamline the storage and retrieval process by using advanced software algorithms, a modular hardware structure, multi-interface communication abilities and a power source.

Along this text, it is considered that a smart locker is an advanced storage and distribution system that incorporates integrated computer and sensor networks to provide enhanced security, management, and convenience over traditional lockers. These systems are designed to automate processes such as package selection, notification, and delivery, making them highly versatile tools for various applications across different industries.

While various smart locker architectures have introduced distributed access management and remote communication, there remains a technical need for a fully autonomous smart locker capable of:
operating with multiple low-power states;
waking up from these states based on multiple triggers;
performing energy-efficient remote activation;
and ensuring reliable operation under intermittent connectivity.

The smart locker device comprises a network with a plurality of lockers, each locker equipped with electronic locks controlled via a central software application. The device is configured to be fully automated, allowing users to securely store and retrieve packages using unique access codes, radio frequency identification (RFID) cards, or biometric identification.

One of the features of the smart locker device now disclosed is its seamless integration with multiple digital platforms, such as e-commerce systems, mobile applications, and IoT devices. This enables users to receive real-time notifications of delivery status, access logs, and security updates via their mobile devices or emails.

The smart locker device also incorporates advanced security features such as encrypted communication protocols, tamper detection sensors, and automated audit logs. These features ensure that the device operates with a high level of security, preventing unauthorized access and providing a complete history of each transaction.

A modular design allows the smart locker device to be easily customized and expanded. Individual lockers can be added or removed depending on the specific needs of the location where the device is deployed. This flexibility makes the device suitable for a wide range of applications, including residential buildings, corporate offices, logistics centers, and retail stores.

The device's user interface is configured to be intuitive and user-friendly. Users can interact with the smart locker device via a touchscreen display or a mobile application, which provides simple step-by-step instructions for retrieving or depositing items. In addition, the device supports multiple languages, enhancing its accessibility for international use.

Another aspect of the technology is its remote management capabilities. System administrators can monitor and control the lockers remotely, perform software updates, and troubleshoot issues in real-time. This eliminates the need for on-site technical personnel and reduces maintenance costs.

The device is further characterized by its ability to integrate with external systems via API connections. This allows the smart locker device to be integrated with courier services, retail platforms, and other third-party applications, enabling automated shipping and receiving processes.

Energy efficiency is another feature of the smart locker device, which uses low-power consumption modules and is designed to operate for extended periods without significant energy usage. The device is also developed for absolute autonomy, i.e. the device does not need any power supply network, since the smart locker device comprises at least one battery. In an embodiment, the device can also be powered by renewable energy sources, such as solar panels.

Overall, the present technology provides a scalable, secure, and versatile smart locker solution that can meet the demands of a variety of users and industries, making it a significant improvement over the prior art.

The smart locker device is configured to operate in multiple operational states, including at least: a sleep state, in which the central control unit and peripherals enter a reduced-power mode; an active state, in which the system is fully powered to permit user interaction and locker control; and, in certain embodiments, an idle state, enabling the system to maintain readiness for input detection while operating with minimal power consumption.

Transitions between these states may be triggered by: a touchscreen input, presence detection via an infrared time-of-flight sensor, mechanical door movement detected by an opening sensor, remote commands transmitted via Short Message Service (SMS) to a wireless modem, or scheduled activation using an internal real-time clock.

To support autonomous operation, in an embodiment, the power source may comprise a swappable battery, preferably front-loadable using a slidable tray equipped with guiding pins for secure alignment. An additional power source, such as solar panels or a connection to mains power, may also be provided.

In an embodiment, the central control unit may include a power management module adapted to monitor available energy sources, switch automatically between them, and optimise energy usage based on predefined conditions.

The communication module may support multiple network types, including Wi-Fi, cellular, or satellite networks, and may be configured to transmit energy status and system data to a remote monitoring platform. The device may operate offline for unforeseen periods of time and automatically synchronize data once connectivity is restored.

In an embodiment, the device may further include: encrypted communication; tamper detection sensors; API integration with external systems; movement detection sensors; and remote management capabilities.

A method for operating the locker compartments is also disclosed, in which access is controlled using unique access codes, RFID cards, or biometric identifiers.

An aspect of the disclosure comprises a smart locker device comprising: a plurality of locker compartments, each locker compartment comprising an electronic lock; a central control unit configured to manage access to said plurality of locker compartments; a user interface configured to enable users to interact with the device and control access to one or more of the plurality of locker compartments; a communication module for remote monitoring and control of the locker device; a power source; wherein the central control unit is configured to manage operational states of the smart locker device, including a sleep state, an idle state and an active state.

In an embodiment, the smart locker device comprises an idle state.

In an embodiment, the sleep state of the smart locker device is a state where the central control unit is configured to enter a reduced-power state to conserve the energy stored in the batteries, but still allowing the user interface to enable users to interact with the device.

In an embodiment, the active state is a state where the central control unit is configured to allow the user interface to enable users to interact with the device and control access to one or more of the plurality of locker compartments.

In an embodiment, the power source of the smart locker device comprises a primary power source comprising at least one battery, preferably a swappable battery, more preferably a front-loadable slidable swappable battery within the smart locker device.

In an embodiment, the smart locker device comprises an additional power source, in particular at least one solar panel.

In an embodiment, the additional power source of the smart locker device is connectable to a mains power network.

In an embodiment, the communication module of the smart locker device is configured to transmit energy status and usage data to a remote monitoring system.

In an embodiment, the central control unit of the smart locker device comprises a power management module that is configured to monitor the availability and status of both the primary power source and the additional power source; automatically select and switch to the primary power source when it is available and functioning within a predetermined operational range; automatically switch to the additional power source when the primary power source is unavailable or falls below the operational range; and optimize energy usage by dynamically selecting between the primary and additional power sources based on predefined conditions, including but not limited to power demand, battery level, and energy efficiency protocols.

In an embodiment, the plurality of locker compartments of the smart locker device each further comprises an opening sensor, in particular an opening sensor in the locker compartment door.

In an embodiment, the smart locker device further comprises an integrated wireless cellular modem that triggers the central control unit to change the operational state of the smart locker device.

In an embodiment, the smart locker device further comprises an internal real-time clock that triggers the central control unit to change the operational state of the smart locker device at predefined time intervals.

In an embodiment, the user interface of the smart locker device comprises a touchscreen display and/or a mobile application and/or a web-based platform.

In an embodiment, the smart locker device comprises an integrated concrete base.

In an embodiment, the smart locker device further comprises integration with external systems via APIs.

In an embodiment, the electronic locks of the smart locker device comprise encrypted communication devices and/or tamper detection sensors.

In an embodiment, the communication module of the smart locker device supports wireless connectivity, including Wi-Fi and cellular networks.

In an embodiment, the smart locker device further comprises a remote management module configured to allow the device control and troubleshoot remotely.

In an embodiment, the smart locker device further comprises a renewable energy source, in particular solar panels or any other suitable renewable energy source.

In an embodiment, the smart locker device operates offline in the event of network connectivity or energy loss for a predefined period of time, and automatically synchronizes data once the connection or energy supply is restored.

In one embodiment, if the smart locker device remains offline for a predefined period, it activates a safety mechanism to restore network connectivity by either searching for available networks with better connectivity or rebooting the system of the device.

In an embodiment, the communication module of the smart locker device switches the on-demand internet connectivity between different network types, including Wi-Fi, cellular, or satellite networks, based on availability and network conditions.

In an embodiment, the smart locker device comprises at least one movement detection sensor.

In an embodiment, the smart locker device comprises a slidable mechanism for battery replacement.

In an embodiment, the mechanism for battery replacement of the smart locker device comprises a shelving mechanism with a tray.

In an embodiment, the shelving mechanism of the smart locker device comprises guiding pins.

It is also disclosed a method for operating one or more of the plurality of locker compartments of the smart locker device, wherein the access to the locker compartment is controlled through unique access codes, RFID cards, or biometric data.

### BRIEF DESCRIPTION OF THE DRAWINGS

The following figures provide preferred embodiments for illustrating the disclosure and should not be seen as limiting the scope of invention.

FIG. 1: Schematic representation of an embodiment of a smart locker device with an exposed view of the power source. The power source container is labelled with the reference number 1, and the metallic tray is labelled with the reference number 2.

FIG. 2: Schematic representation of the software architecture of a smart locker device with an embodiment where the remote wake-up function is realized using SMS communication.

FIG. 3: Schematic representation of the smart locker device detecting the user.

FIG. 4: Schematic representation of a diagram representing the electronic modules currently present within the smart locker device.

FIG. 5: Schematic representation of a power state diagram of the smart locker device.

FIG. 6: Schematic representation of the side view of an embodiment of a smart locker device with an exposed view of the power source. The power source container is labelled with the reference number 1, and the metallic tray is labelled with the reference number 2.

### DETAILED DESCRIPTION

The present disclosure relates to a smart locker device for automated storage and retrieval.

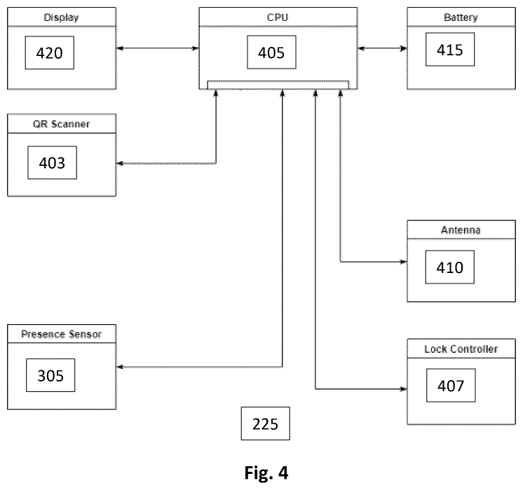

It is disclosed a smart locker device comprising: a plurality of locker compartments, each locker compartment comprising an electronic lock (e.g., 407 in FIG. 4); a central control unit (e.g., 405 in FIG. 4) configured to manage access to said plurality of locker compartments; a user interface configured to enable users to interact with the device and control access to one or more of the plurality of locker compartments; a communication module for remote monitoring and control of the locker device; a power source, wherein the central control unit is configured to manage operational states of the smart locker, including a sleep state and an active state.

In an embodiment, a communication module enables remote monitoring and control. The communication module may include a wireless cellular modem equipped with a SIM card, enabling reception of SMS commands for wake-up or operational changes. If an SMS contains a recognized command (e.g., sleep, idle, active), the modem triggers the central control unit to transition between states. SMS sender authentication may be applied using a whitelist.

The smart locker device operates using at least two power states—sleep and active—and an idle state. In the sleep state, non-essential components are powered down to conserve energy, while the system remains capable of receiving triggers for activation. In the active state, necessary components are powered to allow interaction and locker control. In embodiments including an idle state, the locker maintains minimal functionality for rapid transition to active state while reducing power consumption.

State transitions may be triggered by: touchscreen interaction, wherein the touchscreen sensor generates an interrupt to wake the device; presence detection, using an infrared time-of-flight (TOF) sensor generating a distance-based pixel matrix and signalling the CPU via a microcontroller when an object is detected within a predefined threshold; mechanical door activation, detected by an opening sensor in the locker compartment door; SMS commands, received via the communication module; and/or predefined intervals, managed by an internal real-time clock, enabling periodic activation for synchronisation or system checks.

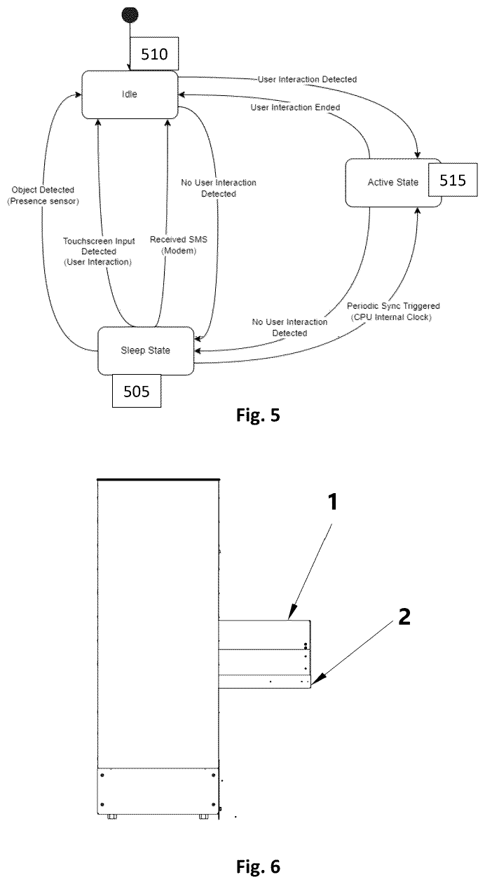

In an embodiment, the power source comprises at least one battery, preferably swappable. In certain embodiments, the battery is mounted in a rectangular metal container (e.g, 1 in FIGS. 1 and 6) with a foldable handle and guiding holes. The battery may be installed in a slidable front-loadable tray (e.g, 2 in FIGS. 1 and 6), optionally metallic, forming part of a shelving mechanism equipped with guiding pins for alignment with the smart locker's power connector. An additional power source, such as solar panels or connection to mains power, may supplement the battery.

In an embodiment, a power management module may monitor the primary and additional power sources, automatically selecting the appropriate source based on operational range, battery level, or predefined energy efficiency protocols.

In an embodiment, locker compartments may include opening sensors, and the product may incorporate movement detection sensors. The device may integrate with third-party systems using APIs, enabling external platforms to trigger delivery, retrieval, or operational commands.

In an embodiment, the communication module may support Wi-Fi, cellular, or satellite networks and may switch between available network types based on availability or network conditions. The device may continue operating offline for unforeseen periods of time and automatically synchronize data once connectivity is restored.

A method is further disclosed for operating locker compartments, wherein access is controlled using unique access codes, RFID cards, or biometric data, such as facial recognition or fingerprint data.

In an embodiment, the sleep state of the smart locker device is a state where the central control unit is configured to enter a reduced-power state to conserve the energy stored in the batteries, but still allowing the user interface to enable users to interact with the device.

In an embodiment, the active state is a state where the central control unit is configured to allow the user interface to enable users to interact with the device and control access to one or more of the plurality of locker compartments.

As mentioned, and to minimize the daily power consumption, the smart locker device can operate in two power states: sleep state and active state. An intelligent active/sleep mechanism manages these power states, switching the smart locker device to active state only as needed in response to user interaction or remotely activated via wireless communication. These two states, sleep and active states, are managed by the central control unit that is configured to automatically transitioning the smart locker device to sleep state after a predefined period of inactivity and enabling the smart locker device to be woken from sleep state by touch input and/or presence sensor and/or mechanical door activation and/or wake-on demand via SMS, which can in particular be made remotely, and/or cloud synchronization. In an embodiment, the text content is encrypted. In an embodiment, the SMS sender undergoes verification, so that if the sender is not on a whitelist, the message is rejected and reported as an error.

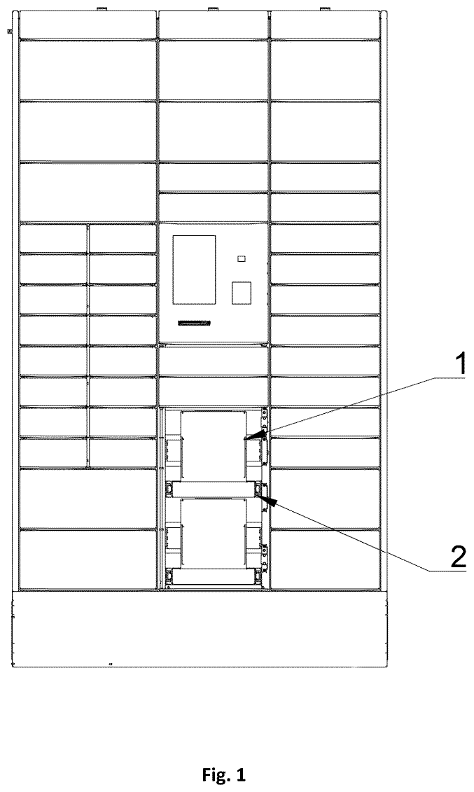

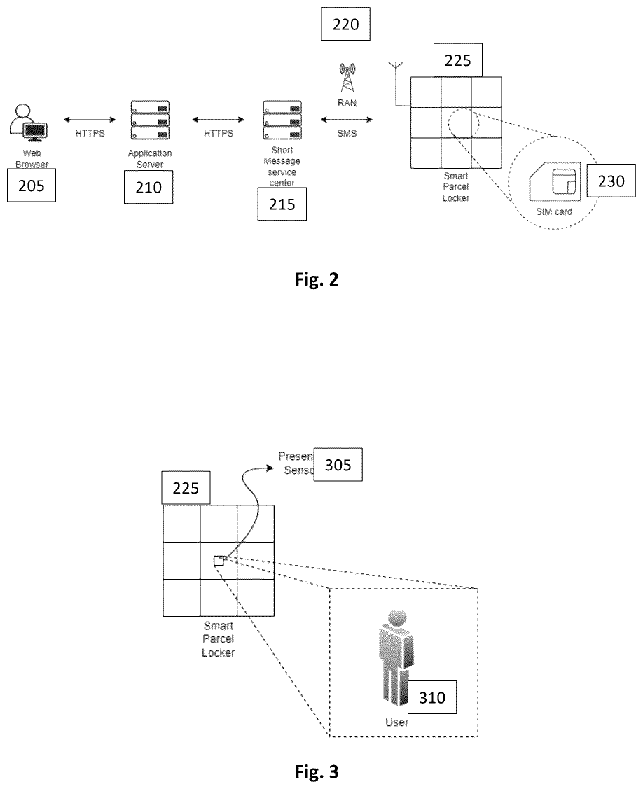

In an embodiment, as illustrated by FIG. 2, the remote wake-up feature of the smart locker is available through a web application. The implementation is based on SMS Application-to-Peer (A2P) communication, which involves the exchange of SMS data between a device and an application using a SMS message.

In an embodiment, the user initiates a request through a web application (e.g., at application server 210 via a web browser 205). The application processes the request and, through a RESTful API endpoint provided by the Short Message Service Center (SMSC) 215, initiates the process to send an SMS message. The API endpoint requires a file containing the device address and the text message. The text message specifies the instructions included in the SMS. So, when the user sends a request to wake up the locker via the web application, the application requests the SMSC 215 to send an SMS through the Radio Access Network (RAN) 220. For this reason, the smart locker 225 is equipped with a communication module, such as a mobile network modem containing a SIM card 230, which receives the SMS message and parses its text content. If the message contains a matching command to active or sleep state, the modem controls the smart locker device 225 to switch its state between sleep and active states as instructed.

This innovative system ensures efficient power management of the lockers by enabling them to transition between active and sleep states on demand.

In the embodiment where the smart locker device is to change the operational state into active state by touch input, this can be achieved by direct user touch on the smart locker's touchscreen. This option uses the user interaction with a touch screen sensor as wake-up source. When the touch screen detects an event sends interrupt signal to central control unit that turns the smart locker device into active state.

In the embodiment where the smart locker device is to change the operational state into active state by presence sensor, this can be achieved by an infrared-based sensor capable of multi-target distance measurements and detects various objects within its field of view (FoV). Upon detecting a nearby individual, the infrared-based sensor sends an interruption signal to the central control unit, enabling the smart locker device to make the transition to active state.

In an embodiment, as illustrated in FIG. 3, the smart locker device 225 is equipped with a presence sensor 305 that comprises a microcontroller and a time-of-flight sensor (TOF) that enables touchless detection of a user 310 approaching the smart locker device 225. The TOF is an infrared-based sensor capable of performing multi-target distance measurements, detecting various objects within its field of view (FoV). It functions by emitting infrared (IR) light and measuring the time it takes for the reflected light to return. Using this data, the sensor 305 generates a pixel matrix, with each pixel representing the measured distance to an object within the field of view. This pixel matrix is then converted into a digital format and transmitted via the I2C (inter-integrated circuit) interface to the microcontroller for processing. The depth map is based on a pixel matrix populated with the different distances/depths measured. The microcontroller calculates the closest distance, and if any pixel is less than a predetermined distance, the microcontroller emits a pulse to the CPU (central processing unit) 405 (see FIG. 4). The CPU 405 has a dedicated hardware input pin for wake-up functionality. When the CPU 405 receives this input, it internally creates an event (interruption) that alters its instructions to transition from sleep state to active state. This sensor 305, upon detecting a nearby individual, sends an interruption signal to wake up the CPU 405, enabling the smart locker device 225 to transition to active state.

In the embodiment where the smart locker device is to change the operational state into active state by mechanical door activation, the smart locker device comprises an opening sensor in the locker compartment door (e.g., lock controller 407) that detects that such locker compartment is being open, which triggers the active state.

In the embodiment where the smart locker device is to change the operational state into active state by wake-on demand via SMS, the smart locker device is equipped with a remote activation feature that allows for immediate intervention via a Short Message Service (SMS) system. The smart locker device can be capable of receiving SMS messages through an integrated wireless cellular modem (including, e.g., antenna 410 in FIG. 4), which serves as a communication interface. Upon receiving a designated SMS command, the wireless cellular modem triggers the activation of the smart locker device, transitioning it from sleep state to active state.

In the embodiment where the smart locker device is to change the operational state into active state by cloud synchronization, the smart locker device uses an internal real-time clock to activate the central control unit at predefined time intervals. This feature allows for scheduled operations, enabling the smart locker device to perform routine checks or tasks even in sleep state, ensuring timely responsiveness when needed.

Along this text, it is considered that sleep state is a low-power state where power is cut to non-essential peripherals, and both the central control unit and the communication module enter in a reduced-power state.

Along this text, it is also considered that active state reactivates the central control unit and the communication module while selectively powering up only necessary components.

In an embodiment, the power source of the smart locker device comprises a primary power source comprising at least one battery (e.g., 415 in FIG. 4), preferably a swappable battery, more preferably a front-loadable slidable swappable battery within the smart locker device.

In an embodiment, the battery in the smart locker device, which in an embodiment can be in a parcel locker compartment, features a shelving mechanism with a tray, in particular a metallic tray, designed for a battery container. This tray allows for front-loading and unloading through a sliding action, ensuring the plug-in mechanism feature. In an embodiment, the shelving mechanism also features guiding pins that precisely align with the battery's connector and the smart locker's power connector, ensuring secure positioning during both insertion and transport.

In an embodiment, the battery is in a rectangular metal container with a foldable handle for portability. It has a single connector for power interlink and built-in guiding holes for stable mounting in various systems.

In an embodiment, the user interface of the smart locker device comprises a touchscreen display (e.g., 420 in FIG. 4) and/or a mobile application and/or a web-based platform, which allows the user to better and quickly interact with the device.

In an embodiment, the smart locker device comprises an integrated concrete base, which avoids the need for works to balance the smart locker device.

In an embodiment, the access to the locker compartment of the smart locker device is controlled through unique access codes, RFID cards, or biometric data. In particular, the biometric data can be fingerprint, facial recognition, iris scanning, among others.

In an embodiment, the smart locker device further comprises integration with external systems via APIs, enabling automated package delivery and retrieval.

In an embodiment, the electronic locks of the smart locker are tamper-resistant and equipped with security features such as encrypted communication and/or tamper detection sensors.

In an embodiment, the communication module of the smart locker device supports wireless connectivity, including Wi-Fi and cellular networks.

In an embodiment, the smart locker device further comprises a remote management module configured to allow the device control and troubleshoot remotely.

In an embodiment, the smart locker device further comprises renewable energy support, in particular solar panels or other renewable energy sources.

In an embodiment, the smart locker device is capable of operating offline for a predefined period of time in the event of network connectivity loss, and automatically synchronizes data once the connection is restored.

In an embodiment, the on-demand internet connectivity of the smart locker device switch between different network types, including Wi-Fi, cellular, or satellite networks, based on availability and network conditions.

In an embodiment, the smart locker device comprises at least one movement detection sensor.

In an embodiment, the smart locker device comprises a mechanism for battery replacement.

As illustrated in FIG. 2, the software architecture of a smart locker device includes a user interface. In an embodiment, this user interface is accessible through a web application, operable via standard web browsers (205). Users initiate requests to active or sleep states of a smart locker directly from this application. Upon receiving the user's request, the web application processes it and communicates with a Short Message Service Center (SMSC) provider 215 using a RESTful API endpoint. The API endpoint requires a file, for example a JSON (JavaScript Object Notation) payload, containing two key elements: the device address, i.e. the mobile number of the smart locker SIM card 230 and a text message with instructions for state change, e.g., active, idle or sleep state. In an embodiment, the SMSC 215 acts as an intermediary, translating HTTPS-based requests from the application server 210 into SMS communications. It transmits the SMS through the Radio Access Network (RAN) 220 to the smart locker 225.

In an embodiment, the smart locker 225 is equipped with a mobile network modem integrated with a SIM card 230. Upon receiving the SMS, the modem parses the message content. If the message matches predefined commands for active, idle or sleeping, the modem signals the locker's central control unit to switch states.

In an embodiment, the smart locker's central control unit (e.g., CPU 405 in FIG. 4) is programmed to interpret specific SMS commands. For instance: A “active” command transitions the locker from a low-power state to an active state. A “sleep” command returns it to a low-power state to conserve energy. A “idle” state command maintains the smart locker ready for input detection.

As illustrated in FIG. 5, the smart locker device can comprise a group of power states. In the sleep state 505, the purpose is to minimize energy consumption by turning off non-essential components, such as peripherals, and reducing the central control unit to a low-power state. The transition to idle state 510 can be triggered by a periodic sync event from the internal clock, where the central control unit performs scheduled synchronization or maintenance tasks before returning to sleep state 505. The transition to active state 515 can be triggered by external inputs, including: touchscreen input detected, i.e. when a user interacts with the touchscreen sensor, an interrupt signal is generated to wake the central control unit; object detected by presence sensor, i.e. an infrared presence sensor detects a nearby individual or object, sending a wake-up signal; a mechanical Door activation, i.e. a position sensor detects movement of the locker door and triggers a wake-up signal. Received SMS via Modem: The wireless cellular modem receives a designated SMS command, which initiates the transition to active state. The main purpose of the idle state 510 is to maintain readiness for rapid response to input events while minimizing energy usage. The transition conditions to active state 515 can be triggered by user interaction, remote activation, or mechanical door movement. The transition conditions to sleep state 505 can be triggered by prolonged inactivity after a defined timeout period. The main purpose of the active state 515 is to power the central control unit and essential peripherals required for immediate operation, such as responding to user inputs or performing communication tasks. The transition conditions to idle state 510 can be triggered when user interaction ends and the transition conditions to sleep state 505 can be triggered by prolonged inactivity, upon completion of communication or periodic tasks.

In an embodiment, the wake-up mechanism is a touchscreen sensor, which detects user interaction with the touchscreen. When an event is detected, the touchscreen sends an interrupt signal to the central control unit to transition from Sleep State to Active State.

In an embodiment, the wake-up mechanism is presence sensor, i.e. an infrared sensor monitors the field of view (FoV) and detects individuals or objects. Upon detection, the sensor generates a signal to wake the smart locker device.

In an embodiment, the wake-up mechanism is mechanical door activation, i.e. the system includes a position sensor that detects the movement or opening of the smart locker door, which triggers an interrupt signal to transition to active state.

In an embodiment, the wake-up mechanism is modem activation via SMS, i.e. an integrated wireless cellular modem allows remote activation of the smart locker device through designated SMS commands. Upon receiving such a command, the modem triggers a signal to activate the central control unit and enter active state. In an embodiment, the smart locker device comprises an internal real-time clock to wake the central control unit at predefined intervals. This feature allows for scheduled operations, enabling the locker to perform routine checks or tasks even in sleep mode, ensuring timely responsiveness when needed.

The term “comprising” whenever used in this document is intended to indicate the presence of stated features, integers, steps, components, but not to preclude the presence or addition of one or more other features, integers, steps, components or groups thereof.

The disclosure should not be seen in any way restricted to the embodiments described and a person with ordinary skill in the art will foresee many possibilities to modifications thereof. The above-described embodiments are combinable.

The following dependent claims further set out particular embodiments of the disclosure.

1. A smart locker device comprising:
a plurality of locker compartments, each locker compartment comprising an electronic lock;
a central control unit configured to manage access to said plurality of locker compartments;
a user interface configured to enable users to interact with the device and control access to one or more of the plurality of locker compartments;
a communication module for remote monitoring and control of the locker device;
a power source;
wherein the central control unit is configured to operate the smart locker device in at least three operational states including:
a sleep state, in which non-essential components are powered down;
an idle state, in which the device maintains low-power readiness for input detection; and
an active state, in which the device enables user interaction and control of the locker compartments.

2. The smart locker device according to claim 1, wherein transitions from the sleep state to the idle state or the active state are triggerable by any of: touchscreen input; presence detection by an infrared time-of-flight sensor; mechanical activation of a locker compartment door detected by an opening sensor; an SMS command received by the communication module; and/or a periodic activation generated by an internal real-time clock.

3. The smart locker device according to claim 1, wherein the power source comprises a primary power source comprising at least one battery, swappable battery, or front-loadable slidable swappable battery within the smart locker device.

4. The smart locker device according to claim 3, comprises an additional power source having at least one solar panel.

5. The smart locker device according to claim 4, wherein the additional power source is connectable to a power network.

6. The smart locker device according to claim 5, wherein the communication module is configured to transmit energy status and usage data to a remote monitoring system.

7. The smart locker device according to claim 3, wherein the central control unit comprises a power management module that is configured to: monitor an availability and status of both the primary power source and the additional power source; automatically select and switch to the primary power source when it is available and functioning within a predetermined operational range; automatically switch to the additional power source when the primary power source is unavailable or falls below the predetermined operational range; and optimize energy usage by dynamically selecting between the primary and additional power sources based on predefined conditions.

8. The smart locker device according to claim 1, wherein the plurality of locker compartments further comprises an opening sensor for each locker compartment door.

9. The smart locker device according to claim 1, further comprising an integrated wireless cellular modem that triggers the central control unit to change the operational state of the smart locker device.

10. The smart locker device according to claim 1, wherein the user interface comprises one or more of a touchscreen display, a mobile application, and a web-based platform.

11. The smart locker device according to claim 1, wherein the electronic lock comprises one or more of encrypted communication and tamper detection sensors.

12. The smart locker device according to claim 1, wherein the communication module supports wireless connectivity, including Wi-Fi and cellular networks.

13. The smart locker device according to claim 1, further comprising a remote management module configured to allow device control and troubleshoot remotely.

14. The smart locker device according to claim 1, wherein the smart locker device operates offline for a predefined period of time during network connectivity or energy loss, and automatically synchronizes data once a connection or energy supply is restored.

15. The smart locker device according to claim 1, wherein the communication module switched internet connectivity between different network types, including Wi-Fi, cellular, or satellite networks, based on availability and network conditions.

16. The smart locker device according to claim 1, further comprising at least one movement detection sensor.

17. The smart locker device according to claim 1, further comprising a slidable mechanism for battery replacement.

18. The smart locker device according to claim 17, wherein the slidable mechanism for battery replacement comprises a shelving mechanism with a tray.

19. The smart locker device according to claim 18, wherein the shelving mechanism comprises guiding pins.

20. The smart locker device according to claim 1, wherein access to the locker compartments is controlled through unique access codes, radio frequency identification (RFID) cards, or biometric data.
